(19) United States
(12) Patent Application Publication
(10) Pub. No.: US 2015/0376869 A1
(43) Pub. Date: Dec. 31, 2015

(54) Method and Apparatus for Machine Synchronization

(71) Applicant: Topcon Positioning Systems, Inc., Livermore, CA (US)

(72) Inventor: Richard Jackson, Redland Bay (AU)

(73) Assignee: TOPCON POSITIONING SYSTEMS, INC., Livermore, CA (US)

(21) Appl. No.: 14/747,039

(22) Filed: Jun. 23, 2015

Related U.S. Application Data
(60) Provisional application No. 62/016,923, filed on Jun. 25, 2014.

(51) Int. Cl. E02F 9/20; E02F 1/00; G05D 1/00

(52) U.S. Cl. CPC E02F 9/2054; G05D 1/0011; E02F 1/00; E02F 9/2045; E02F 9/2041; E02F 9/2058

(57) ABSTRACT

Systems and methods for automating a task of a construction machine include receiving machine data from a first construction machine and a second construction machine. A load balance of the first construction machine is determined based on the received machine data. A location on the first construction machine to release a load is determined based on the load balance. A message is sent to the second construction machine to control movement for releasing a load of the second construction machine at the determined location on the first construction machine.

This application claims the benefit of U.S. Provisional Application No. 62/016,923, filed Jun. 25, 2014, the disclosure of which is herein incorporated by reference in its entirety.

### BACKGROUND OF THE INVENTION

The present invention relates generally to construction site management and more particularly to synchronizing machines at a construction site.

A construction site typically includes a number of different construction machines working together to complete tasks of a construction project. The completion of a task in a safe and efficient manner depends on the level of skill and experience of the operator. For example, an inexperienced operator may perform tasks that results in inefficiency, increased wear and tear on the machine, unsafe workplace conditions, and increased operator fatigue. Synchronizing constructions machines to exchange data between constructions machines may allow for aid the operator in performing the tasks. Synchronizing construction machines to exchange data of the machine and other relevant information is especially important in a construction site environment, where multiple construction machines cooperate with or depend upon each other to complete a task.

### BRIEF SUMMARY OF THE INVENTION

Systems and methods for automating a task of a construction machine include receiving machine data from a first construction machine and a second construction machine. A load balance of the first construction machine is determined based on the received machine data. A location on the first construction machine to release a load is determined based on the load balance. A message is sent to the second construction machine to control movement for releasing a load of the second construction machine at the determined location on the first construction machine.

These and other advantages of the invention will be apparent to those of ordinary skill in the art by reference to the following detailed description and the accompanying drawings.

### BRIEF DESCRIPTION OF THE DRAWINGS

FIG. 1 depicts an exemplary excavator, in accordance with one or more embodiments;

FIG. 2 illustratively depicts a high-level overview of a construction site including a plurality of construction machines, in accordance with one or more embodiments;

FIG. 3 depicts an exemplary synchronization system for exchanging information between construction machines, in accordance with one or more embodiments;

FIG. 4 depicts an exemplary connectivity system for exchanging information between construction machines, in accordance with one or more embodiments;

FIG. 5 depicts a construction site having an excavator loading a dump truck, in accordance with one or more embodiments;

FIG. 6 shows a flow diagram for a method for automating a task of a construction machine, in accordance with one or more embodiments; and

FIG. 7 depicts a high-level schematic of a computer system, in accordance with one or more embodiments.

### DETAILED DESCRIPTION

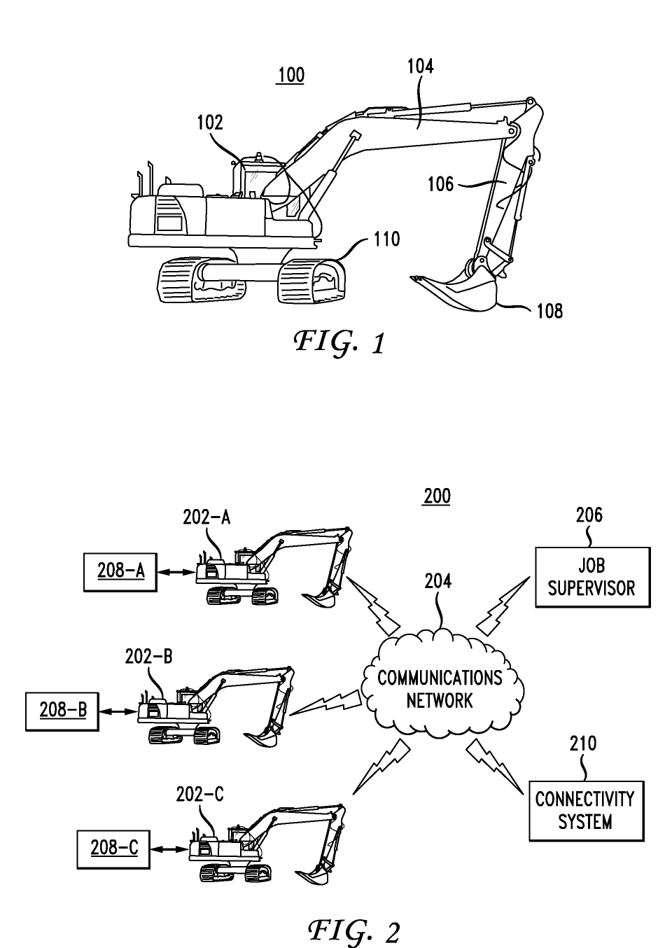

FIG. 1 shows an exemplary construction equipment or machine, in accordance with one or more embodiments. The machine in FIG. 1 is shown as an excavator 100. Excavator 100 includes cab 102, boom 104, stick 106, and bucket 108. Cab 102, boom 104, stick 106, and bucket 108 are rotatably mounted on an undercarriage 110 of excavator 100, which may include tracks or wheels. An operator controls excavator 100 from cab 102 to move it to a desired location and manipulate various materials, such as dirt. Excavator may have one or more sensors (not shown) to provide on-board measurements, such as, e.g., location, load, tilt, etc.

A construction project may involve multiple machines (e.g., excavator 100) that work together to complete a task. The completion of the task in a safe and efficient manner depends on the ability of the machines and their operators to effectively communicate with each other. For example, excavator 100 may communicate with other machines at a construction site to indicate the stress on boom 104, the current load of bucket 108, and the location of undercarriage 110.

FIG. 2 shows a high-level overview of a construction site 200 in accordance with one or more embodiments. Construction site 200 includes machines or devices 202-A, 202-B, and 202-C, collectively referred to as machines 202. Machines 202 may include any machine or device for construction, such as, e.g., a bulldozer, dump truck, crane, excavator, or any other type of equipment. In one embodiment, machines 202 include excavator 100 shown in FIG. 1. It should be understood that while machines 202 are shown in FIG. 2 as machines 202-A, 202-B, and 202-C, machines 202 may include any number of machines of a same or different type.

Communications network 204 facilitates communication between two or more machines 202, operators of machines 202, and/or job supervisor 206. Communications network 204 may include any suitable network, such as, e.g., a wired or wireless computer network, the Internet, a telephone network, a cellular network, a satellite network, etc. In one embodiment, communications network 204 is a mesh network where each machine 202, operator, and/or job supervisor 206 acts as a node to cooperate in the distribution of data. In this embodiment, each node is communicatively coupled with all other nodes (that are within communication range) to provide peer-to-peer communication.

Operators may directly communicate over communications network 204 using one or more computing devices, which can be independent of their associated machines 202. Computing devices include any device capable of communicating over communications network 204, such as, e.g., a mobile phone, a tablet, a computer, smart glasses, etc.

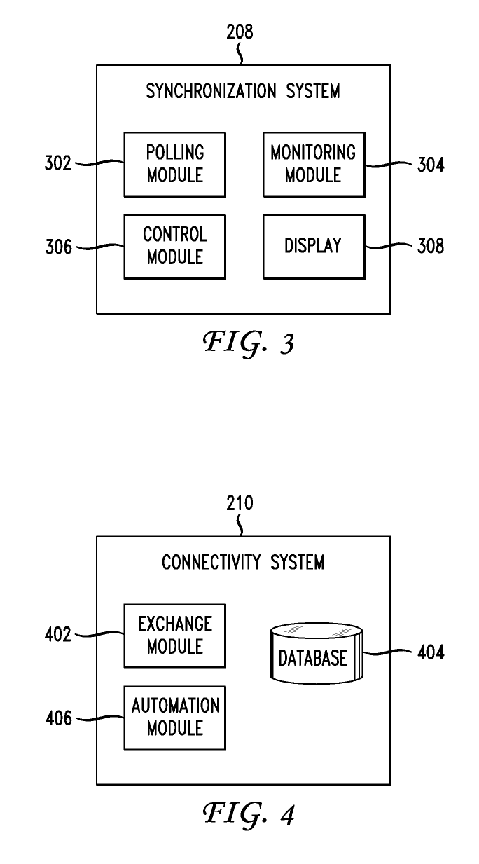

Each machine 202-A, 202-B, and 202-C includes an associated synchronization system 208-A, 208-B, and 208-C, respectively, collectively referred to as synchronization system 208. Synchronization system 208 is communicatively coupled to respective machines 202. For example, synchronization system 208 may be a module of machine 202 or may be an external system communicatively coupled to machine 202. Synchronization system 208 facilitates the exchange of information between two or more machines 202 (or other systems or databases) through communications network 204 (e.g., a peer-to-peer mesh network). FIG. 3 shows a detailed view of synchronization system 208.

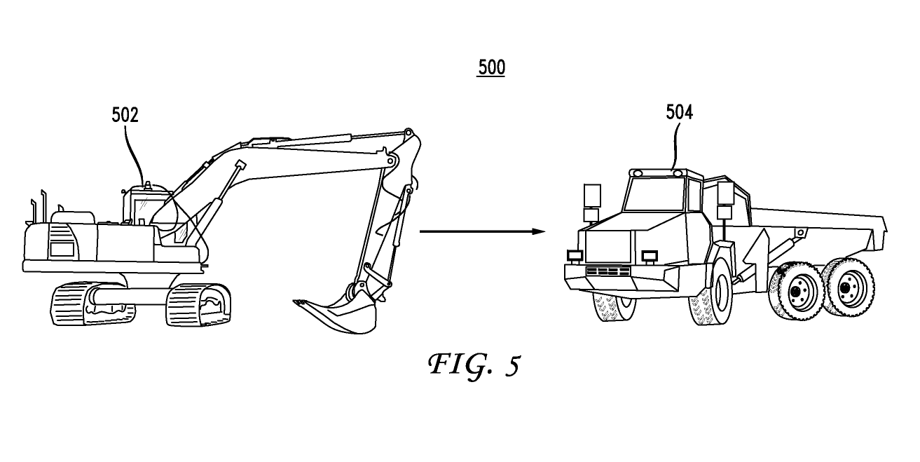

Synchronization system 208 may also communicate with connectivity system 210 over communications network 204. FIG. 4 shows a detailed view of connectivity system 210. An operator, job supervisor 206, or any other user may interact with synchronization system 208 and/or connectivity system 210 for the exchange of information and automation of tasks. Job supervisor 206 oversees the planning and operations of the entire construction project of construction site 200, e.g., from a site office. In one embodiment, connectivity system 210 is located at the site office and job supervisor 206 interacts with connectivity system 210 directly. The site office may include a gateway to connect communications network 204 to an outside network (e.g., Internet).

FIG. 3 shows an exemplary synchronization system 208 in accordance with one or more embodiments. Polling module 302 polls machine data from, or sends machine data to, other machines. For example, polling module 302 of synchronization system 208-A of machine 202-A will poll machine 202-C for machine data via communications network 204. In another example, polling module 302 of synchronization system 208-A of machine 202-A sends machine data to machine 202-B via communications network 204.

The machine data may include on-board measurements and identification information of the machine. The on-board measurements may be provided directly by the machine, such as, e.g., engine load data, cylinder pressure, speed, etc. In one embodiment, the machine may also include sensors to provide on-board measurements such as, e.g., swing data, tilt, positioning, etc. The sensors may include, e.g., motion sensors, tilt sensors, load sensors, proximity sensors, rotary encoders, positioning systems (e.g., global navigation satellite system), imaging systems (e.g., cameras, radars, scanners), etc. Identification information identifies the machine that the on-board measurements are associated with. For example, identification information may include “who-am-I” identification data which identifies the machine. Identification information may also include vehicular dimensions, load-carrying capacities for various material types, company plant (machine) numbers, etc.

In one example, excavator 100 of FIG. 1 may include synchronization system 208 to work with a machine to complete a task. The machine may poll sensors on excavator 100 to provide on-board measurements indicating the location of undercarriage 110, the speed or acceleration of the tracks or wheels of undercarriage 110, the swing of stick 106, the load on buck 108, etc. Excavator 100 may also be polled directly to determine engine load data and other data of the machine. Other types of data may also be polled from excavator 100.

Polling module 302 may also request and receive other relevant information (e.g., relating to the machine, the construction project, the performance of the operator, data on other operators, etc.) from an external database or system (e.g., connectivity system 210, from another machine, etc.) connected directly or indirectly (e.g., through the Internet) to communications network 204. For example, an excavator may request data from connectivity system 210 on the maximum capacity of a dump truck that it is filling. This other relevant information may also include information pertaining to the construction site environment, such as, e.g., the type of material being manipulated (e.g., dirt, concrete), special considerations or properties of the material being manipulated, the weather forecast, etc. This other relevant information may additionally or alternatively be stored locally at the machine, such as, e.g., in a low-cost on-board controller.

Monitoring module 304 determines what machine data to aggregate and display from data received by polling module 302 to provide feedback to an operator, job supervisor 206, or any other user. For example, monitoring module 304 of synchronization system 208-A of machine 202-A may receive feedback from machine data received from machine 202-C. The data may include machine data received from other machines or may include other relevant information from another system (e.g., connectivity system 210). In one embodiment, monitoring module 304 displays raw, unprocessed data. For example, monitoring module 304 may display (using display 308) the current load-tonnage via the on-board weighing system of a machine 202, the pressure at various locations of a bed of a machine 202 via a strut pressure-monitoring system, the maximum capacity of the machine 202, etc. In other embodiments, monitoring module 304 may first process the data and then display the processed data. For example, the current load and maximum capacity may be processed to display the current load as a percent of the maximum capacity, the pressure at various locations of a bed may be represented as a percentage at each location, etc. Processing the machine data may alternatively or additionally be performed at connectivity system 210.

Monitoring module 304 may involve one or more display elements (e.g., display 308), sound actuators, or any other types of notification devices to provide feedback in real-time or near real-time. In one embodiment, display 308 includes augmented reality display devices for augmenting a live direct view of the physical world with information relating to the task, the construction project, and/or other information. For example, windows of cab 102 of excavator 100 of FIG. 1 can be configured as the augmented reality display to provide an augmented reality view to the operator. Other examples of augmented reality display devices include a head-mounted display such as a visor of a protective helmet, smart glasses, contact lenses, etc.

Control module 306 may control machine 202 to automate, at least in part, the completion of one or more tasks. Control module 306 may involve a combination of hardware and software to provide a platform for all machine interaction and control computations. In one embodiment, control module 306 receives control messages (e.g., from connectivity system 210) directing the automation. Control module 306 then control the machine in accordance with the control messages. In another embodiment, control module 306 may locally process machine information to perform the automation of tasks such as, e.g., where the task does not involving interaction with other machines. The automation of tasks will be discussed in more detail below.

FIG. 4 shows an exemplary connectivity system 210 in accordance with one or more embodiments. Connectivity system 210 interacts with synchronization system 208 on machines 202 for the exchange and synchronization of information and automation of tasks.

Exchange module 402 sends and receives information to and from machines 202 over communications network 204. In one embodiment, exchange module 402 receives machine information from machines 202, which can be used for monitoring performance of the operator, providing feedback to the operator, automating tasks, storing records, etc. The machine information may be stored in database 402. In some embodiments, e.g., where connectivity to database 402 is unavailable through communications network 204, a machine 202 may act as a local collection point. Once connectivity to connectivity system 210 is restored, the machine 202 may then exchange the machine information with exchange module 402.

Exchange module 402 may also exchange other relevant information (e.g., relating to the machine, the construction project, the performance of the operator, data on other operators, etc.) with machines 202. This other relevant information may be stored in database 402. The other relevant information may be provided by a user (e.g., job supervisor 206), a manufacturer, or any other source.

Automation module 406 works with control module 306 of one or more machines 202 to automate tasks. Automation module 406 combines knowledge of individual machine geometries, kinematics, machine-to-machine relational information and other relevant information to automate tasks. In one embodiment, automation module 406 directs the automation of one or more machines 202 to automate a task. For example, automation module 406 may send control messages to control module 306 for controlling its respective machine. Automation module 406 may direct the automation based on machine information from one or more (or all) machines 202 in construction site 200, which is received by exchange module 402 and stored in database 404.

The automation of a task (by control module 306 or automation module 406) may involve an operator training control module 306 or automation module 406 by manually performing the task one or multiple times. The automation of the task is performed in accordance with machine data from the machine to be controlled or other machines involved in the task. For example, the truck load-imbalance data from polling module 302 is processed (e.g., by control module 306, automation module 406) to determine the exact release location in the bed of a machine to provide a balanced load. The operator can resume control of the machine at any point in time (e.g., by pressing a button, interacting with controls of the machine, etc.).

The automated task may be performed according to operating procedures stored locally at the machine, at other machines, at database 404, or at any other suitable location (e.g., that is retrievable via communications network 204). The operating procedures may be stored as models for performing a task. The models define parameters of a task, such as, e.g., static and dynamic geometrical constraints, hydraulic pressure targets for optimal usage, engine load targets for optimal usage, speed and acceleration limits, etc. The models may define operating procedures as a best operator would perform. In one embodiment, the parameters of a model are defined according to specifications from the manufacturer of the machine. In another embodiment, the parameters of a model are defined by a user (e.g., job supervisor 206, operator) to customize the model for a particular task or construction project.

FIG. 5 shows an exemplary construction site 500 in accordance with one or more embodiments. Excavator 502 excavates dirt in construction site 500 and loads it into dump truck 504. Excavator 502 and dump truck 504 include synchronization systems 208. The operator of excavator 502 may manually control the task of digging. However, the monotonous lift-swing-and-release loading process may be automated. For example, the operator may interact with control module 306 (FIG. 3) of excavator 502 by, e.g., pressing a button to initiate the automated task of loading dump truck 504. On-board measurements of excavator 502 and dump truck 504, as well as other machine information and relevant data, are processed by automation module 406 (FIG. 4), which are applied against a model of operational practices to provide control messages. Automation module 406 sends the control messages to control module 306 of excavator 502 to direct the automation of loading dump truck 504. The exact release location is determined based on the load-imbalance data from sensors on dump truck 504 to balance the load in dump truck 504. Excavator 502 then returns to its original position upon completion of the task. The operator can resume control of excavator 502 at any point in time. Advantageously, the automation of tasks provides for a more safe and efficient construction environment 500.

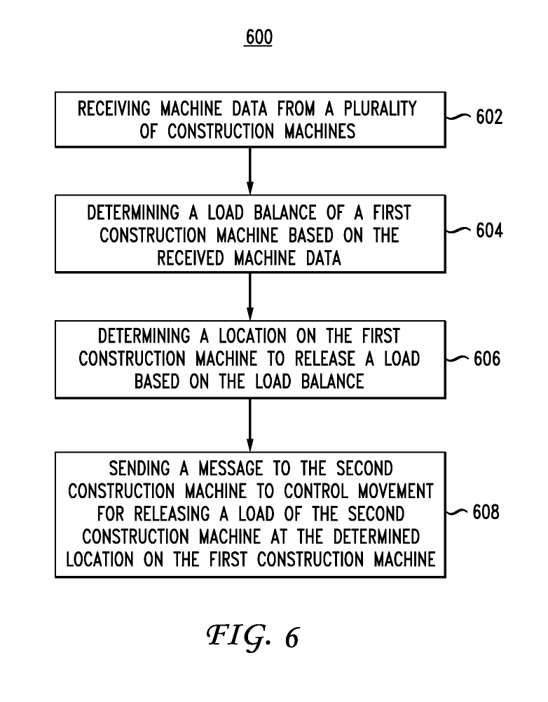

FIG. 6 shows a flow diagram of an exemplary method 600 for automating a task of a construction machine using machine synchronization, in accordance with one or more embodiments. Method 600 may be performed by, e.g., connectivity system 210. In some embodiments, method 600 may alternatively (or additionally) be performed by synchronization system 208 associated with a construction machine.

At step 602, machine data is received from a plurality of construction machines. The plurality of construction machines includes a first construction machine and a second construction machine. While method 600 may be illustratively explained herein with respect to the first construction machine being a dump truck and the second construction machine being an excavator, it should be appreciated that the first construction machine and second construction machine may include any type of construction machines.

The machine data may be received over a communications network, such as, e.g., a peer-to-peer mesh network. The machine data received from the plurality of construction machines may include on-board measurements and identification information. The on-board measurements may be provided directly by a construction machine or by sensors placed on the construction machine. For example, one or more load sensors (e.g., weight sensors) may be placed throughout the bed of the dump truck or may be placed on a bucket of the excavator. The identification information may identify the construction machine and may include specifications for that construction machine (e.g., dimensions of the bed of the dump truck, load-carrying capacities, etc.). In some embodiments, additional data (e.g., weather forecast, properties of the material being manipulated, etc.) may also be received from a database, job supervisor, or any other entity.

At step 604, a load balance of the first construction machine (e.g., dump truck) is determined based on the received machine data. For example, the received machine data may include the current load measurements polled from each load sensor placed throughout the bed of the dump truck. The load balance may be determined by analyzing a balance between the load at each sensor location.

At step 606, a location on the first construction machine (e.g., bed of the dump truck) to release a load is determined based on the load balance. In one embodiment, the load balance may indicate that a region of the bed of the dump truck has the least amount of weight. In this embodiment, the location is determined as the location on the dump truck having the least amount of weight. In other embodiments, where the load balance indicates that the bed of the dump truck is balanced, the location may be determined as a predetermined location, such as, e.g., the center of the bed of the dump truck. In some embodiment, the location is also determined based on machine data from the second construction machine (e.g., excavator), such as, e.g., the load of the bucket of the excavator. For example, where the load of the bucket of the excavator would result in the dump truck exceeding its maximum load capacity, the excavator may be prevented from releasing its load.

At step 608, a message is sent to the second construction machine (e.g., excavator) to control movement for releasing a load of the excavator at the determined location on the first construction machine (e.g., dump truck). In one exemplary embodiment, the first construction machine (e.g., dump truck) sends its tray size, height, orientation, and location (and other pertinent information) to the second construction machine (e.g., excavator) via the (e.g., peer-to-peer mesh) network. The dump truck sends its optimum load location to the excavator via the network. For example, the optimum load location may be represented as an XY offset relative to some reference point (e.g., center of the bed, a corner of the bed, etc.) on the bed of the dump truck. Based on the received machine data (e.g., tray size, height, orientation, and location) and the optimum load location, the excavator calculates the exact coordinate at which to release its load. In some embodiments, the first loading task will be performed manually so the machines kinematics for the specific geometrical relationship can be learned and applied to subsequent loads. For example, the excavator's boom, stick and bucket trajectories are recorded and then replayed with modifications based on load balancing as reported by the truck. These trajectory calculations may be performed by the control module of the excavator and not by the dump truck. In one embodiment, the calculations may also take into consideration data other than just the trucks location and stance, such as, e.g., other sensors data that contributes to the excavators “environmental-awareness” and which may be used to modify swing radii and other actions of the excavator.

The automated task (e.g., moving the boom, stick, and bucket of the excavator) may be performed according to models defining operating procedures and other parameters of the task, such as, e.g., static and dynamic geometrical constraints, hydraulic pressure targets for optimal usage, engine load targets for optimal usage, speed and acceleration limits, load capacities for a construction machine operated on a particular terrain, etc.). In one embodiment, the models define operating procedures as a best operator would perform. The models may also be customized, e.g., by a user of the excavator, a job supervisor, etc.

In one embodiment, a user of the excavator manually performs the task of excavating and the loading procedure of lift-swing-and-release of the load in the bucket into the bed of the dump truck is automated to provide for an optimal balance in the bed of the dump truck. The automated loading procedure may be initiated by, e.g., the user pressing a button. The user of the excavator may override the automated task at any time by, e.g., manipulating controls of the excavator.

Data may be transmitted to the excavator for display on a display element. For example, the load of the bucket of the excavator and at sensor locations of the bed of the dump truck may be displayed. In some embodiments, the machine data may be processed to, e.g., show the load as a percentage of the maximum load capacity. The display may show a predicted animated loading process that will be performed based on the current conditions. The display may also show warnings or alerts, such as, e.g., proximity to other construction machines, unsuitable impending weather, etc.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 6. Certain steps of the methods described herein, including one or more of the steps of FIG. 6, may be performed by a server or by another processor in a network-based cloud-computing system. Certain steps of the methods described herein, including one or more of the steps of FIG. 6, may be performed by a client computer in a network-based cloud computing system. The steps of the methods described herein, including one or more of the steps of FIG. 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

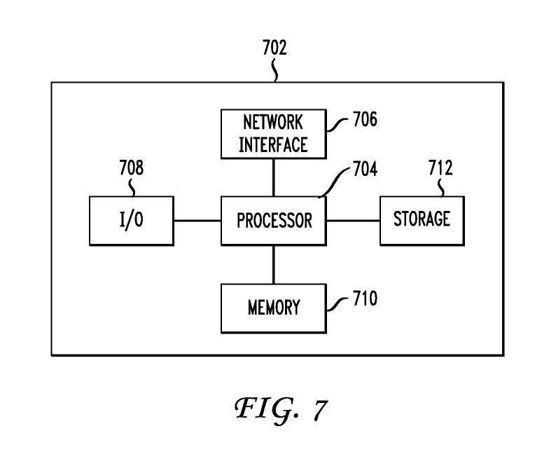

A high-level block diagram 700 of an example computer that may be used to implement systems, apparatus, and methods described herein is depicted in FIG. 7. Computer 702 includes a processor 704 operatively coupled to a data storage device 712 and a memory 710. Processor 704 controls the overall operation of computer 702 by executing computer program instructions that define such operations. The computer program instructions may be stored in data storage device 712, or other computer readable medium, and loaded into memory 710 when execution of the computer program instructions is desired. Thus, the method steps of FIG. 6 can be defined by the computer program instructions stored in memory 710 and/or data storage device 712 and controlled by processor 704 executing the computer program instructions. For example, the computer program instructions can be implemented as computer executable code programmed by one skilled in the art to perform the method steps of FIG. 7. Accordingly, by executing the computer program instructions, the processor 704 executes the method steps of FIG. 6. Computer 702 may also include one or more network interfaces 706 for communicating with other devices via a network. Computer 702 may also include one or more input/output devices 708 that enable user interaction with computer 702 (e.g., display, keyboard, mouse, speakers, buttons, etc.).

Processor 704 may include both general and special purpose microprocessors, and may be the sole processor or one of multiple processors of computer 702. Processor 704 may include one or more central processing units (CPUs), for example. Processor 704, data storage device 712, and/or memory 710 may include, be supplemented by, or incorporated in, one or more application-specific integrated circuits (ASICs) and/or one or more field programmable gate arrays (FPGAs).

Data storage device 712 and memory 710 each include a tangible non-transitory computer readable storage medium. Data storage device 712, and memory 710, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 708 may include peripherals, such as a printer, scanner, display screen, etc. For example, input/output devices 708 may include a display device such as a cathode ray tube (CRT) or liquid crystal display (LCD) monitor for displaying information to the user, a keyboard, and a pointing device such as a mouse or a trackball by which the user can provide input to computer 702.

Any or all of the systems and apparatus discussed herein, including synchronization system 208 of FIG. 3 and connectivity system 210 of FIG. 4, may be implemented using one or more computers such as computer 702.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for automating a task of a construction machine, comprising:
receiving machine data from a first construction machine and a second construction machine;
determining a load balance of the first construction machine based on the received machine data;
determining a location on the first construction machine to release a load based on the load balance; and
sending a message to the second construction machine to control movement for releasing a load of the second construction machine at the determined location on the first construction machine.

2. The method as recited in claim 1, wherein determining a location on the first construction machine to release a load based on the load balance comprises:
determining the location on the first construction machine that will balance a load of the first construction machine.

3. The method as recited in claim 2, wherein determining the location on the first construction machine that will balance a load of the first construction machine comprises:
determining the location on the first construction machine as a location having a least amount of load.

4. The method as recited in claim 1, wherein receiving machine data from a first construction machine and a second construction machine comprises:
receiving measurements from a plurality of load sensors placed throughout a bed of the first construction machine.

5. The method as recited in claim 1, further comprising:
receiving data from the second construction machine as a user of the second construction machine manually releases the load of the second construction machine.

6. The method as recited in claim 1, wherein sending a message to the second construction machine to control movement for releasing a load of the second construction machine at the determined location on the first construction machine comprises:
sending the message to the second construction machine to control movement for releasing the load of the second construction machine at the determined location on the first construction machine based on models defining operating procedures for the releasing the load of the second construction machine.

7. The method as recited in claim 1, wherein sending a message to the second construction machine to control movement for releasing a load of the second construction machine at the determined location on the first construction machine comprises:
sending the message to the second construction machine to control movement by controlling actuators of the second construction machine for moving a boom and a stick of the second construction machine and releasing a load of a buck of the second construction machine at the determined location.

8. The method as recited in claim 1, further comprising:
sending display data to the second construction machine based on the machine data.

9. The method as recited in claim 8, wherein sending display data to the second construction machine based on the machine data comprises:
sending display data for displaying a predicted loading process.

10. The method as recited in claim 1, wherein the first construction machine includes a dump truck and the second construction machine includes an excavator.

11. A apparatus for automating a task of a construction machine, comprising:
a processor; and
a memory to store computer program instructions, the computer program instructions when executed on the processor cause the processor to perform operations comprising:
receiving machine data from a first construction machine and a second construction machine;
determining a load balance of the first construction machine based on the received machine data;
determining a location on the first construction machine to release a load based on the load balance; and
sending a message to the second construction machine to control movement for releasing a load of the second construction machine at the determined location on the first construction machine.

12. The apparatus as recited in claim 11, wherein determining a location on the first construction machine to release a load based on the load balance comprises:
determining the location on the first construction machine as a location having a least amount of load.

13. The apparatus as recited in claim 11, wherein receiving machine data from a first construction machine and a second construction machine comprises:
receiving measurements from a plurality of load sensors placed throughout a bed of the first construction machine.

14. The apparatus as recited in claim 11, wherein sending a message to the second construction machine to control movement for releasing a load of the second construction machine at the determined location on the first construction machine comprises:
sending the message to the second construction machine to control movement for releasing the load of the second construction machine at the determined location on the first construction machine based on models defining operating procedures for the releasing the load of the second construction machine.

15. The apparatus as recited in claim 11, wherein sending a message to the second construction machine to control movement for releasing a load of the second construction machine at the determined location on the first construction machine comprises:
sending the message to the second construction machine to control movement by controlling actuators of the second construction machine for moving a boom and a stick of the second construction machine and releasing a load of a buck of the second construction machine at the determined location.

16. A computer readable medium storing computer program instructions for automating a task of a construction machine, which, when executed on a processor, cause the processor to perform operations comprising:
receiving machine data from a first construction machine and a second construction machine;
determining a load balance of the first construction machine based on the received machine data;
determining a location on the first construction machine to release a load based on the load balance; and
sending a message to the second construction machine to control movement for releasing a load of the second construction machine at the determined location on the first construction machine.

17. The computer readable medium as recited in claim 16, wherein determining a location on the first construction machine to release a load based on the load balance comprises:
determining the location on the first construction machine as a location having a least amount of load.

18. The computer readable medium as recited in claim 16, wherein receiving machine data from a first construction machine and a second construction machine comprises:
receiving measurements from a plurality of load sensors placed throughout a bed of the first construction machine.

19. The computer readable medium as recited in claim 16, the operations further comprising:
sending display data to the second construction machine based on the machine data.

20. The computer readable medium as recited in claim 19, wherein sending display data to the second construction machine based on the machine data comprises:
sending display data for displaying a predicted loading process.
